(19) United States
(12) Patent Application Publication
(10) Pub. No.: US 2015/0120426 A1
(43) Pub. Date: Apr. 30, 2015

(54) Consolidating and Leveraging Features of a Loyalty Program

(71) Applicant: Bank of America Corporation, Charlotte, NC (US)

(72) Inventors: Carrie Anne Hanson, Charlotte, NC (US); James Vernot, Willimgton, DE (US); Laura Caine, Bear, DE (US); Kristen Dunn, Chadds Ford, PA (US); Colleen Margaret Fellows, Middletown, DE (US); Jeffrey N. Healy, Matthews, NC (US); Amber L. Thorneburg, Charlotte, NC (US); Olaf G. Schweidler, West Chester, PA (US)

(21) Appl. No.: 14/593,167

(22) Filed: Jan. 9, 2015

Related U.S. Application Data
(63) Continuation of application No. 12/831,872, filed on Jul. 7, 2010.

(51) Int. Cl. G06Q 30/02

(52) U.S. Cl. CPC G06Q 30/0226
USPC 705/14.27

(57) ABSTRACT

Aspects of the disclosure relate to a computer assisted method for consolidating reward points or monetary rewards associated with one or more financial accounts which may include electronically receiving information regarding a financial transaction in a first financial account, determining an amount of reward points or monetary rewards based on the financial transaction in the first account, and crediting a reward points or monetary rewards account associated with the first account with the amount of reward points or monetary rewards based on the transaction with the first financial account. The method may include electronically receiving information regarding a transaction in a second financial account, determining an amount of reward points or monetary rewards based on the financial transaction in the second financial account and crediting the reward points or monetary rewards account with the amount of reward points or monetary rewards based on the transaction with the second financial account.

### CROSS-REFERENCE TO RELATED APPLICATIONS

This application is a continuation of and claims priority to co-pending U.S. application Ser. No. 12/831,872, filed Jul. 7, 2010, and entitled “Consolidating and Leveraging Features of a Loyalty Program,” which is incorporated herein by reference in its entirety.

### FIELD OF DISCLOSURE

Aspects of the present disclosure relate to financial accounts and transactions. Particular aspects of the present disclosure relate to accumulating, consolidating, and leveraging features of loyalty programs, such as reward points or monetary rewards, that are associated with financial accounts and transactions.

### BACKGROUND

Many organizations, such as banks or other financial institutions, offer loyalty or reward programs to their customers. Loyalty programs may vary based on the particular organization, but typically loyalty programs are designed to reward customers of the organization for being a patron of, or otherwise supporting, the organization. Further, loyalty programs may be designed to provide some incentive or encouragement for the customers to continue to patronize, or support, the organization. For example, some loyalty programs may include providing customers with some type of credit (e.g., currency in the form of “points”/“reward points” or actual money). Reward points may be credits that customers accumulate and redeem for various goods and services. For example, once the customer has accumulated a predetermined amount of reward points, the customer may redeem the reward points for a particular selection of goods or services. As another example, the customer may accumulate actual money (e.g., reward funds, or monetary rewards) instead of reward points (e.g., through a “money back” or “cash back” program that credits the customer with a particular amount of money based on particular factors, such as the value of the transaction).

Typically, a customer may have different accounts within a particular financial institution or different accounts with different financial institutions and, therefore, generates reward points or monetary rewards in several different accounts (e.g., several different rewards accounts). However, having reward points or monetary rewards in different accounts (both within a particular financial institution and/or at other financial institutions) may be inefficient, cumbersome, and create other potential drawbacks. Therefore, it would be beneficial to be able to more efficiently and effectively accumulate reward points or monetary rewards in a loyalty program. Hence, it would be advantageous to have a system and method which more efficiently and effectively accumulates reward points or monetary rewards in a loyalty program.

### SUMMARY

Aspects of the present disclosure relate to a computer assisted method for consolidating reward points or monetary rewards associated with one or more financial accounts which may include electronically receiving information regarding a financial transaction in a first financial account, determining an amount of reward points or monetary rewards based on the financial transaction in the first account, and crediting a reward points or monetary rewards account associated with the first account with the amount of reward points or monetary rewards based on the transaction with the first financial account. Further, the method may include electronically receiving information regarding a transaction in a second financial account, determining an amount of reward points or monetary rewards based on the financial transaction in the second financial account and crediting the reward points or monetary rewards account with the amount of reward points or monetary rewards based on the transaction with the second financial account. Further, the first financial account may be a credit card account and the second financial account may be an account associated with a debit card. Further, an earn rate of rewards points or monetary rewards for the financial transactions may be the same regardless of whether the financial transaction is authorized by a signature or by a Personal Identification Number (PIN).

Further aspects of the present disclosure relate to a reward points or monetary rewards consolidating computer which may include a processor and a memory, wherein the memory may store computer executable instructions that may cause the processor to perform a method wherein reward points or monetary rewards associated with one or more financial accounts may be generated and consolidated into a single account by electronically receiving information regarding a financial transaction in a first financial account, determining an amount of reward points or monetary rewards based on the financial transaction in the first account and crediting a reward points or monetary rewards account associated with the first account with the amount of reward points or monetary rewards based on the transaction with the first financial account. Further, the method may include electronically receiving information regarding a transaction in a second financial account, determining an amount of reward points or monetary rewards based on the financial transaction in the second financial account and crediting the reward points or monetary rewards account with the amount of reward points or monetary rewards based on the transaction with the second financial account. Further, the first financial account may be a credit card account and the second financial account may be an account associated with a debit card. Further, an earn rate of reward points or monetary rewards for the financial transactions may be the same regardless of whether the financial transaction is authorized by a signature or by a PIN.

Additional aspects of the present disclosure relate to a computer assisted method for consolidating reward points or monetary rewards associated with one or more financial accounts which may include electronically receiving information regarding a financial transaction in a first financial account, determining an amount of reward points or monetary rewards based on the financial transaction in the first account and crediting a reward points or monetary rewards account associated with the first account with the amount of reward points or monetary rewards based on the transaction with the first financial account. Further, the method may include electronically receiving information regarding a transaction in a second financial account, determining an amount of reward points or monetary rewards based on the financial transaction in the second financial account and crediting the reward points or monetary rewards account with the amount of reward points or monetary rewards based on the transaction with the second financial account. The method may further include electronically receiving information regarding a customer's relationship with an organization awarding the reward points or monetary rewards and determining an earn rate of reward points or monetary rewards based on the information regarding the customer's relationship with the organization.

### BRIEF DESCRIPTION OF THE DRAWINGS

FIG. 1 illustrates a diagram of a general-purpose digital computing environment in which certain aspects of the present disclosure may be implemented;

FIG. 2 is a block diagram of a illustrative system for generating reward points or monetary rewards and accumulating reward points or monetary rewards into a single account according to aspects of the present disclosure;

FIGS. 3, 4 and 5 are a flow chart of an illustrative example of a method for generating reward points or monetary rewards and accumulating reward points or monetary rewards into a single account according to aspects of the present disclosure; and

FIGS. 6, 7 and 8 are a flow chart of an illustrative example of a method for generating reward points or monetary rewards and accumulating reward points or monetary rewards into a single account according to aspects of the present disclosure.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made.

It is noted that throughout the disclosure, the term organization may be used interchangeably with the terms: bank, financial institution, company, business, entity, and the like. The term organization is not intended to be limiting, but instead merely describes a single potential embodiment according to aspects of the disclosure. Further, it is noted that throughout the disclosure, the term reward point may be used interchangeably with the terms: credit, point, reward credits, and the like. The term reward point is not intended to be limiting, but instead merely describes a single potential embodiment according to aspects of the disclosure. Additionally, the tern monetary rewards may be used interchangeable with money, actual money, cash, and the like, as term or monetary rewards may refer to actual funds (e.g., bank notes, and the like) that are given as a reward if particular conditions are satisfied. The term monetary rewards is not intended to be limiting, but instead merely describes a single potential embodiment according to aspects of the disclosure.

As discussed above, having reward points or monetary rewards in different accounts (both within a particular financial institution and/or within other financial institutions) may create potential drawbacks. For example, accumulating a predetermined number of reward points or a predetermined amount of monetary rewards in a single rewards account (e.g., the number of reward points or the amount of monetary rewards necessary in order to redeem a particular good or service) may take a longer period of time than if reward points or monetary rewards from the different accounts were consolidated into a single account. Therefore, aspects of the disclosure relate to a system and method which more efficiently and effectively accumulates reward points or monetary rewards in a loyalty program. Further, aspects of the disclosure relate to a system and method which accumulates reward points or monetary rewards from a customer's different accounts into a single account.

According to aspects of this disclosure, an organization such as a bank, financial institution, business, and the like, may have loyalty or rewards programs which reward particular customer behavior. For example, a loyalty or rewards program may reward a customer when the customer makes particular financial transactions. For example, according to aspects of the disclosure, the loyalty program of a particular bank financial institution, business, and the like, may reward a customer for using a debit card issued by, or otherwise associated with, the particular bank. For example, the loyalty or rewards programs may reward a customer for conducting debit card transactions.

A debit card transaction may be considered a method of conducting a financial transaction wherein a customer draws funds directly from a financial account (e.g., a checking account, a savings account, and the like) to pay for a particular item. Further, in a debit card transaction, the customer may use the physical debit card in order to draw funds directly from the financial account. As will be discussed in detail below, during a debit card transaction, a customer may authorize the drawing of funds in various ways. For example, according to aspects of the disclosure, the customer may authorize a debit card transaction using a code associated with the card (e.g., a numeric code, such as a personal identification number or (PIN)). For example, during a transaction, a customer may insert their debit card in a card reader (e.g., “swipe” the debit card through a card reader) which may extract information from the card (e.g., a routing number associated with a customer's account with the bank, an account number associated with the customer's account with the bank, the customer's name, and the like). Thereafter, the customer may enter a personalized PIN number associated with the debit card which may authenticate the person as a valid user of the debit card and authorize the transaction as a valid transaction. Hence, once the financial transaction has been approved, the bank associated with the account from which the funds are to be debited, will deduct the funds from the account and provide the funds to the merchant or other party with which the customer conducted the transaction.

According to aspects of the disclosure, the customer may authorize a debit card transaction using a signature instead of code (e.g., a PIN). For example, as described above, during a transaction, a customer may insert their debit card in a card reader (e.g., as described above) which may extract information from the card (e.g., as described above). Thereafter, the bill or receipt associated with the transaction may be presented to the customer in order for the customer to review and execute, or sign. For example, this may be done by presenting a physical bill or receipt (e.g., a paper bill or receipt) which the customer may sign with an ink pen or an electronic bill (e.g., on an electronic display device) which the customer may sign with a stylus, electronic pen, finger, and the like. The customer's signature may authenticate the person as a valid user of the debit card and authorize the transaction as a valid transaction. As described above once the financial transaction has been approved, the bank associated with the account from which the funds are to be debited, will deduct the funds from the account and provide the funds to the merchant or other party with which the customer conducted the transaction.

According to aspects of the disclosure, the loyalty program of a particular bank may reward a customer for using a credit card issued by, or otherwise associated with, the particular bank. For example, according to aspects of the disclosure, the loyalty or rewards programs may reward a customer for conducting credit card transactions. A credit card transaction may be considered a method of conducting a financial transaction wherein a customer draws funds from a financial account, wherein the customer has agreed to pay back any funds the customer draws from that financial account. In a credit card transaction, the customer may use the physical credit card in order to draw funds from the financial account. As will be discussed in detail below, during a credit card transaction, a customer may authorize the drawing of funds in various ways.

For example, according to aspects of the disclosure, the customer may authorize a credit card transaction using a signature. For example, as described above, during a transaction, a customer may insert their credit card in a card reader (e.g., “swipe” the credit card through a card reader) which may extract information from the card (e.g., an account number associated with the customer's account, a numeric confirmation or security code number associated with a customer's account (e.g., a three digit numeric code), the customer's name, and the like). Thereafter, the bill or receipt associated with the transaction may be presented to the customer in order for the customer to review and execute, or sign. For example, this may be done with by presenting a physical bill or receipt (e.g., a paper bill or receipt) which the customer may sign with an ink pen or an electronic bill (e.g., on an electronic display device) or receipt which the customer may sign with a stylus, electronic pen, finger, and the like. The customer's signature may authenticate the person as a valid user of the credit card and authorize the transaction as a valid transaction. As described above, once the financial transaction has been approved, the bank associated with the account from which the funds are to be drawn, will deduct the funds from the account and provide the funds to the merchant or other party with which the customer conducted the transaction.

It is noted that other methods of conducting or authenticating debit card transactions or credit card transactions may be used as well. For example, online transactions wherein the customer electronically signs (e.g., typing the customers name or typing the customer's name between forward slash marks as an indicator of the electronic signature, and the like), or transactions conducted over the telephone, wherein the customer provides credit or debit card information and authorizes the transaction orally may be used as well. Additionally, according to some examples of the disclosure, the customer may have an infrared (IR) or radio frequency (RF) device (e.g., a fob type device, smart card type device, and the like) which is associated with a credit or debit card account. Hence, the customer may conduct and authorize a credit or debit card transaction by authenticating the transaction using the IR or RF device in conjunction with a receiver associated with the merchant and through which the financial transaction information may be processed (e.g., the customer may hold the IR or RF device in a close proximity to the merchant's receiver. It is noted that the above examples of conducting or authenticating debit card transactions or credit card transactions are merely illustrative, and other methods of conducting or authenticating debit card transactions or credit card transactions may be used as well.

By rewarding the customer with features of a loyalty program, the organization may provide an incentive for (and thereby encourage) customers to conduct financial transactions using methods of payment associated with that particular organization. This may be advantageous for the particular business, because it may serve to increase business and, perhaps, profitability for the organization. Further, the loyalty program may generate increase goodwill from the customers towards the organization, as customers who are able to receive benefits through the loyalty program may feel that the organization values them as customers, and the like.

According to aspects of the disclosure, a loyalty program may provide the customer with reward points, or points. According to aspects of the disclosure, the number of points awarded to the customer may be based on the value or amount of the financial transaction conducted by the customer. For example, if the customer conducted a financial transaction in which the customer used their debit card to purchase an item worth $100.00, the customer may be rewarded with 100 points.

According to aspects of the disclosure, a loyalty program may provide the customer with monetary rewards. According to aspects of the disclosure, the amount of money awarded to the customer may be based on the value or amount of the financial transaction conducted by the customer. For example, the customer may be rewarded an amount of money that is a predetermined percentage of the financial transaction (e.g., 1% of the transaction). For example, if the customer conducted a financial transaction in which the customer used their debit card to purchase an item worth $100.00, the customer may be rewarded an amount of with $1.

According to aspects of the disclosure, once the customer has accumulated a predetermined amount of reward points, the customer may redeem the reward points for goods or services. Further, according to aspects of the disclosure, in loyalty programs, the number of reward points needed to obtain a particular good or service may be related to the value of the good or service. For example, redeemable goods or services that have higher values (e.g., are more expensive) may have a higher predetermined threshold of reward points associated with that good or service. Hence, customers may have to accumulate a larger number of reward points in order to be able to redeem goods or services of greater value. Similarly, once the customer has accumulated an amount or monetary rewards in the reward account, the customer may be able to withdraw that amount of money in cash, transfer it to a particular financial account, apply the money to a particular purchase, and the like.

According to aspects of the disclosure, the loyalty program may include a feature that allows points or monetary rewards generated from different types of transactions to be accumulated in a single account. For example, according to aspects of the disclosure, points or monetary rewards generated from debit card transactions and points or monetary rewards generated from credit card transactions may be accumulated in a single account (e.g., a rewards points account or a monetary rewards account). According to aspects of the disclosure, the single account may be primarily associated with a credit card account or may be primarily associated with a debit card account. Alternatively, according to aspects of the disclosure, the single account may be primarily associated with the customer and not necessarily primarily associated with either the credit card account or the debit card account.

By accumulating points or monetary rewards from both credit card transactions and debit card transactions into a single account, points or monetary rewards may be accumulated more effectively than if the points or monetary rewards were to be accumulated in separate accounts. For example, if points or monetary rewards from credit card transactions were accumulated in a first account and points or monetary rewards from debit card transactions were accumulated in a second account and the points or monetary rewards were not combinable, then it would take more transactions in each account (or at least a larger amount of funds associated with the transactions in each account and, typically, a longer amount of time) to reach a predetermined threshold of points or a predetermined amount of monetary rewards in that particular account wherein the customer could redeem the points for a particular good or service associated with that threshold of points or withdraw, or otherwise utilize, the monetary rewards. Hence, according to aspects of the disclosure, because the points or monetary rewards from different types of transactions (e.g., debit and credit card transaction) are accumulated in a single account, the customer may more effectively and, potentially more quickly, utilize the points or monetary rewards.

For example, according to aspects of the disclosure, if a customer made a $50.00 purchase with a debit card and a $50.00 purchase with a credit card transaction, the customer may receive 100 points in their single reward points account (assuming the points were valued at $1:1 point ratio) or $1 in their single monetary rewards account (assuming a 1% rate of monetary rewards to the transaction amount). In contrast, if a customer made a $50.00 purchase with a debit card and a $50.00 purchase with a credit card transaction and points or monetary rewards went to separate reward accounts (e.g., a first account associated with the debit card and a second account associated with the credit card), then each account would accumulate 50 points (assuming the points were valued at $1:1 point ratio) or $0.50 (assuming a 1% rate of or monetary rewards to the transaction amount). Hence, it is seen, that accumulating points or monetary rewards in each account separately would take more transactions in each account (or at least a larger amount of funds associated with the transactions in each account and, typically, a longer amount of time) to reach a predetermined threshold of points or a predetermined amount of monetary rewards in that particular account wherein the customer could redeem the points for a particular good or service associated with that threshold of points or withdraw, or otherwise utilize, the monetary rewards. This may be frustrating for a customer as it may take longer for the customer to accumulate enough points to redeem an item the customer wants, or even any item at all, or even generate a significant amount of monetary rewards. Hence, features of the disclosure which allows points or monetary rewards from different types of transactions (e.g., debit and credit card transaction) to be accumulated in a single account may increase goodwill for the organization because the customer may more effectively and, potentially more quickly, utilize the monetary rewards or the points to redeem goods or services.

According to aspects of the disclosure, points or monetary rewards from credit card transactions and points or monetary rewards from debit card transactions may be automatically generated and included a single account. For example, each time a debit card transaction or a credit card transaction is conducted, the points or monetary rewards associated with that transaction may be automatically generated and accumulated in the single account.

Alternatively, according to aspects of the disclosure, points or monetary rewards from credit card transactions that are accumulated in a first account and points or monetary rewards from debit card transactions are accumulated in a second account may be able to be transferred into a single account (e.g., a reward points or monetary rewards account primarily associated with the customer and not necessarily primarily associated with either the credit card account or the debit card account). However, it is noted that aspects of the disclosure in which points or monetary rewards are automatically generated and accumulated in the single account avoids the need to transfer the points or monetary rewards between accounts.

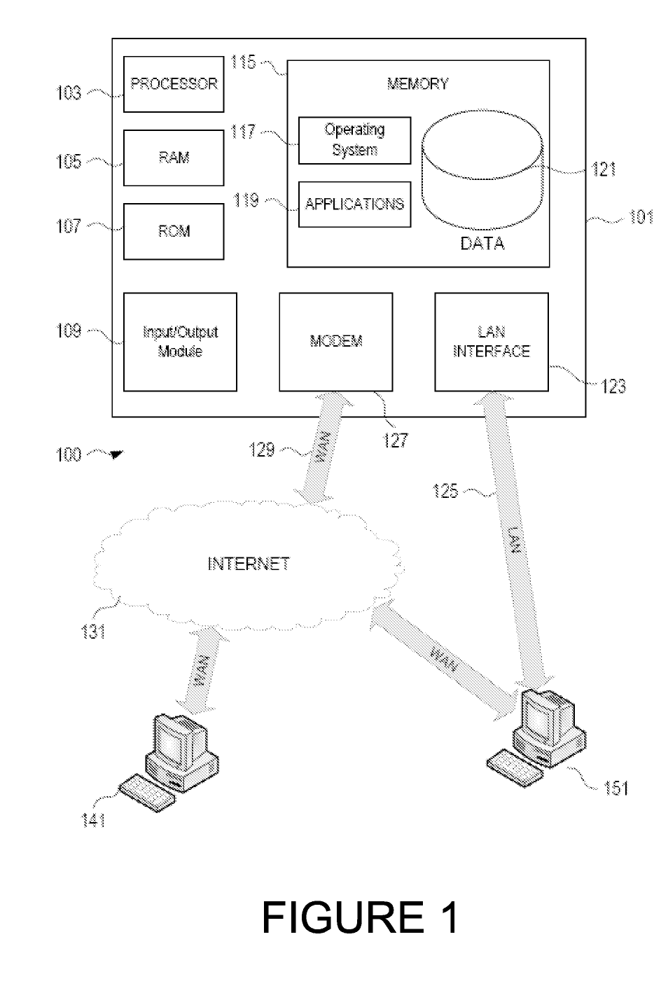

FIG. 1 illustrates an example of a suitable computing system environment 100 that may be used according to one or more illustrative embodiments of the invention. The computing system environment 100 is only one example of a suitable computing environment and is not intended to suggest any limitation as to the scope of use or functionality of the invention. Neither should the computing system environment 100 be interpreted as having any dependency nor requirement relating to any one or combination of components illustrated in the exemplary computing system environment 100.

Aspects of the disclosure are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Aspects of the disclosure may be described in the general context of computer-executable instructions, such as program modules, being executed by a computer. Generally, program modules include routines, programs, objects, components, data structures, and the like, that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, input/output module 109, and memory 115. Computer 101 typically includes a variety of computer readable media. Computer readable media may be any available media that may be accessed by computer 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 101. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. Although not shown, RAM 105 may include one or more are applications representing the application data stored in RAM memory 105 while the computer is on and corresponding software applications (e.g., software tasks), are running on the computer 101.

Input/output module 109 may include a microphone, keypad, touch screen, and/or stylus through which a user of computer 101 may provide input, and may also include one or more of a speaker for providing audio output and a video display device for providing textual, audiovisual and/or graphical output. Software may be stored within memory 115 and/or storage to provide instructions to processor 103 for enabling computer 101 to perform various functions. For example, memory 115 may store software used by the computer 101, such as an operating system 117, application programs 119, and an associated database 121. Alternatively, some or all of computer 101's computer executable instructions may be embodied in hardware or firmware (not shown). As described in detail below, the database 121 may provide centralized storage of account information and account holder information for the entire business, allowing interoperability between different elements of the business residing at different physical locations.

Computer 101 may operate in a networked environment supporting connections to one or more remote computers, such as branch terminals 141 and 151. The branch computers 141 and 151 may be personal computers or servers that include many or all of the elements described above relative to the computer 101. The network connections depicted in FIG. 1 include a local area network (LAN) 125 and a wide area network (WAN) 129, but may also include other networks. When used in a LAN networking environment, computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are exemplary and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the computer 101 according to an illustrative embodiment of the invention may include computer executable instructions for invoking user functionality related to communication, such as email, short message service (SMS), and voice input and speech recognition applications.

Terminals 141 or 151 may also be mobile terminals including various other components, such as a battery, speaker, and antennas (not shown). Input/output module 109 may include a user interface including such physical components as a voice interface, one or more arrow keys, joystick, data glove, mouse, roller ball, touch screen, or the like.

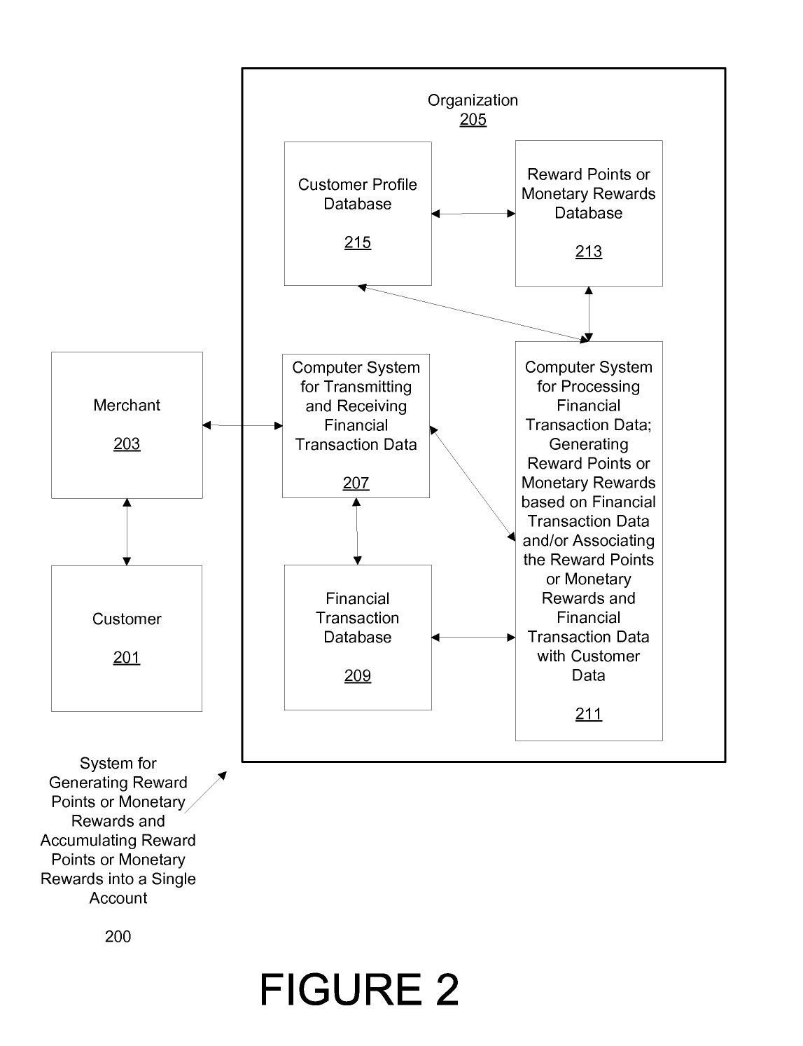

An illustrative system and method for generating reward points or monetary rewards and accumulating reward points or monetary rewards into a single account according to aspects of this disclosure will be described in detail below with reference to the FIG. 2. FIG. 2 is a diagram which shows a system 200 for generating reward points or monetary rewards and accumulating reward points or monetary rewards into a single account according to aspects of this disclosure. As seen in FIG. 2, a customer 201 conducts a financial transaction with a merchant 203. According to aspects of this disclosure, the merchant 203 may transmit information regarding the financial transaction to the organization 205 via the computer system for transmitting and receiving financial transaction data 207. For example, the merchant 203 may transmit a request for approval of the transaction to the organization 205 via the computer system for receiving financial transaction data 207. Further, the merchant 203 may receive approval of the transaction from the organization 205 via the computer system for transmitting and receiving financial transaction data 207. According to aspects of the disclosure, the system 200 may also include one or more financial transaction databases 209 which store data related to financial transactions. The computer system for transmitting and receiving financial transaction data 207 may transmit data to and receive data from one or more of the organization's financial transaction databases 209.

Further, according to aspects of the disclosure, the system for generating reward points or monetary rewards and accumulating reward points or monetary rewards into a single account 200 may include a computer system 211 for processing financial transaction data, generating reward points or monetary rewards based on financial transaction data and/or associating the reward points or monetary rewards and financial transaction data with customer data. As seen in FIG. 2, the computer system 211 may transmit data to and receive data from the financial transaction database 209 and the computer system for transmitting and receiving financial transaction data 207.

Further, according to aspects of the disclosure, the system for generating reward points or monetary rewards and accumulating reward points or monetary rewards into a single account 200 may also include one or more reward points or monetary rewards databases 213 which stores data related to reward points or monetary rewards. Further, according to aspects of the disclosure, the system for generating reward points or monetary rewards and accumulating reward points or monetary rewards into a single account 200 may also include one or more customer profile databases 215 which stores data related to customers. The computer system for processing financial transaction data, generating reward points or monetary rewards based on financial transaction data and/or associating the reward points or monetary rewards and financial transaction data with customer data 211 may transmit data to and receive data from one or more of the organization's reward points or monetary rewards databases 213 and one or more of the customer profile databases 215.

The above described system for generating reward points or monetary rewards and accumulating reward points or monetary rewards into a single account represented in FIG. 2 will be described in more detail below. However, it is noted here that one or more of the elements in the above described system 200 (e.g., the computer system for transmitting and receiving financial transaction data 207, the computer system for processing financial transaction data, generating reward points or monetary rewards based on financial transaction data and/or associating the reward points or monetary rewards and financial transaction data with customer data 211, and databases 209, 213 and 215) may include a computer system with a processor, a memory or both.

As described above, according to aspects of this disclosure, an organization 205 may have one or more computer systems 207 that are used for transmitting, receiving and processing data related to a financial transaction between a bank customer and a merchant. Examples of data related to a financial transaction between a bank customer and a merchant, may include: the date of the financial transaction, the time of the financial transaction, the location of the financial transaction, the merchant 203 and customer 201 with whom the financial transaction was conducted, the items purchased by the customer during a financial transaction, bank routing numbers, customer account numbers, security codes, PINs, and the like.

The computer systems 207 used for transmitting, receiving and processing financial transaction data, may be configured to allow merchants to input such financial transaction data (e.g., via a web based system). For example, the merchant 203 may transmit the financial transaction data, such as described above, to the computer system 207. According to aspects of the disclosure, the computer systems 207 for transmitting, receiving and processing financial transaction data 207 may transmit the data for storage in one or more databases (e.g., financial transaction databases 209). For example, if a merchant 203 enters financial transaction data, then the financial transaction data may be stored in a financial transaction database 209 associated with the computer systems 207 used for transmitting, receiving and processing the financial transaction. Also, the financial transaction database 209 used for receiving and processing transaction data may be configured to transmit the financial transaction data (e.g., to other computer systems or databases within the organization 205).

Further, as described above, according to one or more aspects of the disclosure, the organization 205 may have one or more computer systems 211 for processing financial transaction data, generating reward points or monetary rewards based on financial transaction data and/or associating the reward points or monetary rewards and financial transaction data with customer data. For example, the computer system 211 may be configured to search for, indentify, extract and process data from the above described computer systems 207 used for transmitting, receiving and processing the financial transaction and the financial transaction database 209. Further, the computer system 211 may be configured to generate reward points or monetary rewards based on such financial transaction data, associate with particular reward accounts and customer profile accounts associated with a respective customer who conducted the financial transaction, and transmit the data to respective reward accounts in the reward points or monetary rewards databases 213 and respective customer profile accounts in the customer profile database 210.

As described above, according to aspects of this disclosure, a bank may have one or more databases 213 used for storing data related to customers' rewards accounts. Further, a bank may have one or more computer systems associated with the databases 213 which are used for capturing and processing data about customers' rewards accounts. As described above, such a rewards account may be a single account associated with a customer into which rewards points or monetary rewards from different types of financial transactions associated with the customer may be accumulated. The customers' rewards accounts stored in the one or more databases 213 for storing data related to customers' rewards accounts may include data such as reward points or monetary rewards balances, earn rates, details on particular financial transactions from which one or more reward points or an amount of monetary rewards were generated, details on other methods in which the one or more reward points or the amount of monetary rewards were generated, and the like.

Similarly, as described above, according to aspects of this disclosure, a bank may have one or more databases 215 used for storing data related to customers' profiles. Further, a bank may have one or more computer systems associated with the one or more databases 215 which are used for capturing and processing data about current customers and their financial relationships with the bank, such as: customer name, address, telephone number, email address, age, income, place of employment (and its contact information, such as address, telephone numbers, and the like), type of household (e.g., double income household, children, single adult), type of residence (home owner (e.g., condo, house), renter (e.g., apartment)), the type of financial relationship/account (e.g., a loan, insurance, deposit account, checking account, savings account, credit card account, and the like), term of the relationship (e.g., term of a loan, the time current customer has been with the bank, and the like), particular relevant financial amounts in the relationship (e.g., monthly payments, total debt, interest rate, and the like), if one or more of the payments on the account have been made from a deposit account with a second bank, routing numbers and account numbers, whether automatic payments are set up to receive funds from a second bank, and the like. Such customer profile data may be stored in the one or more customer profile databases 215.

According to aspects of this disclosure, in order for a customer 201 to participate in the system 200, the customer 201 may be required to register with the organization 205. According to an embodiment of the disclosure, wherein the organization 205 is a bank, the customer 201 may have an account with the bank (e.g., a debit card account, a credit card account, and the like), have provided particular information to the bank, such as contact information, residence information, or other information such as described above.

According to aspects of this disclosure, if a customer 201 registers with the organization 205 and participates in the system 200, then the customer 201 may be assigned a rewards account (associated with their other account(s) with the bank, such as the customer's credit card account, debit card account (e.g., checking account, savings account, and the like), and the like) through which the customer 201 may generate and accumulate reward points or monetary rewards. According to aspects of the disclosure, the computer system 200 or portions thereof may be a web based system. Therefore, according to aspects of the disclosure, the customer 201 may access the computer system 200 or portions thereof (e.g., rewards account) via the internet from a personal computer, smart phone, and the like, by, for example, providing an identification number (such as an account number) and password. Of course, other methods of authenticating the customer 201 may be used as well. Once the customer 201 has accessed the account, the customer 201 may examine data (e.g., financial transaction data, balances, and the like) related to their respective accounts with the bank.

As discussed above, according to aspects of the disclosure, different types of financial transactions, such as credit card transactions, debit card transactions, and the like, may accumulate points or monetary rewards. Further, according to aspects of the disclosure, some or all of the different types of financial transactions may be eligible for generating reward points or monetary rewards, regardless of the particular different methods in which the financial transactions are conducted. For example, according to aspects of the disclosure, a debit card transaction may be eligible for generating reward points or monetary rewards if it is conducted as a transaction through which the customer executed, or signed, the bill or receipt (as discussed above) in order to authenticate or authorize the transaction. Further, according to aspects of the disclosure, a debit card transaction may be eligible for generating reward points or monetary rewards if it is conducted as a transaction through which the customer provided a PIN (as discussed above) in order to authenticate or authorize the transaction. Additionally, according to aspects of the disclosure, a credit card transaction may be eligible for generating reward points or monetary rewards if it is conducted as a transaction through which the customer executed or signed the bill or receipt (as discussed above) in order to authenticate or authorize the transaction. Hence, it is understood that according to aspects of the disclosure, different types of financial transactions, may accumulate reward points or monetary rewards, regardless of the particular different methods in which the financial transactions are conducted. Further, according to other aspects of the disclosure, if desired, financial transactions only by particular methods may be eligible for generating rewards points or monetary rewards.

Further, according to aspects of the disclosure, some or all of the different types of financial transactions may be eligible for generating reward points or monetary rewards regardless of the particular items involved in the financial transactions. For example, according to aspects of the disclosure, a debit card transaction or a credit card transaction may be eligible for generating reward points or monetary rewards, regardless of the good or service purchased. For example, according to aspects of the disclosure, the type of good or service (e.g., clothing, travel expenses, food, and the like) may be eligible for generating reward points or monetary rewards. Further, according to other aspects of the disclosure, if desired, financial transactions for only particular types of goods or services may be eligible for generating reward points or monetary rewards.

Further, according to aspects of the disclosure, some or all of the different types of financial transactions may be eligible for generating reward points or monetary rewards regardless of the particular amount of funds involved in the financial transactions. For example, according to aspects of the disclosure, a debit card transaction or a credit card transaction may be eligible for generating reward points or monetary rewards, regardless of the amount of funds involved in purchasing the good or service. For example, according to aspects of the disclosure, inexpensive goods or services (e.g., one dollar or less) may still be eligible for generating reward points or monetary rewards. Further, according to other aspects of the disclosure, if desired, only financial transactions that meet a predetermined amount of money may be eligible for generating reward points or monetary rewards.

As discussed above, loyalty programs may include a earn rate at which reward points or monetary rewards are generated based on the financial transactions conducted by the customer. As discussed above, an example earn rate for reward points based on financial transaction may be of a ratio of 1 reward point: 1 dollar involved in the financial transaction. Further, an example earn rate for monetary rewards may be based on the financial transaction and may be 1% of the amount of money involved in the financial transaction. However, the above described examples are merely illustrative examples, and according to aspects of the disclosure, earn rates may be varied as desired. For example, earn rates may be 0.5, 2, 3, 4, and the like, reward points: 1 dollar involved in the financial transaction. Further, earn rates may be 0.5%, 2%, 3%, 4%, of the amount of money involved in the financial transaction. Further, the reward points or monetary rewards may be awarded for spending predetermined intervals in a purchase (e.g., 1 reward point of every $20 increment spent in the transaction, such as 5 points for a $100 transaction or $1 reward dollar for every $20 increment spent in the transaction, such as $5 of monetary rewards for a $100 transaction).

According to aspects of the disclosure, earn rates may be the same for any eligible financial transaction. Further, according to other aspects of the disclosure, earn rates may be varied per transaction based on a variety of factors. For example, according to aspects of the disclosure, earn rates for credit card transactions may be different than for debit card transactions (e.g., 2 reward points: 1 dollar for a credit card transaction and 1 reward point: 1 dollar for debit card transaction or monetary rewards in the amount of 2% of the financial transaction amount for a credit card transaction and monetary rewards in the amount of 1% of the financial transaction amount for a debit card transaction). According to aspects of the disclosure, earn rates may be varied based on the type of item involved in the financial transaction (e.g., 2 reward points: 1 dollar for merchandise purchases and 1 reward point: 1 dollar for service purchases or monetary rewards in the amount of 2% of the financial transaction amount for merchandise purchases and monetary rewards in the amount of 1% of the financial transaction amount for service purchases). According to aspects of the disclosure, earn rates may be varied based on the amount of funds involved in the financial transaction (e.g., 4 reward points: 1 dollar for purchases over $400 and 1 reward point: 1 dollar for purchases under $400 or monetary rewards in the amount of 2% of the financial transaction amount for a purchases over $400 and monetary rewards in the amount of 1% of the financial transaction amount for purchases under $400). According to aspects of the disclosure, earn rates may be varied based on the method in which the financial transaction is conducted (e.g., 2 reward points: 1 dollar for signature transactions and 1 reward point: 1 dollar for PIN transactions or monetary rewards in the amount of 2% of the financial transaction amount for signature transactions and monetary rewards in the amount of 1% of the financial transaction amount for PIN transactions). According to aspects of the disclosure, earn rates may be varied based on the customer conducting the financial transaction (e.g., 2 reward points: 1 dollar for customers who have purchased over $5,000 under the loyalty program and 1 reward point: 1 dollar for customers who have purchased less than $5,000 under the loyalty program or monetary rewards in the amount of 2% of the financial transaction amount for customers who have purchased over $5,000 under the loyalty program and monetary rewards in the amount of 1% of the financial transaction amount for customers who have purchased under $5,000 under the loyalty program). While the above examples are merely illustrative, it will be understood that earn rates may be varied based on a variety of factors.

According to aspects of the disclosure, a loyalty program may include bonuses, or enhancers, for customers based on various factors as will be discussed in detail below. According to aspects of the disclosure, bonuses, or enhancers, in the loyalty program may include providing predetermined amounts of reward points or monetary rewards based on various customer behaviors. Further, bonuses, or enhancers, in the loyalty program may include modifying the earn rate (e.g., for predetermined periods of time or for specific purchases) based on various customer behavior. Further, bonuses, or enhancers, in the loyalty program may include providing a multiplier for the number of reward points or monetary rewards that would normally be awarded in a transaction (e.g., earning triple or quadruple points in a transaction or earning triple or quadruple the amount of or monetary rewards) based on various customer behavior. Further, bonuses, or enhancers, in the loyalty program may include a multiplier for the balance of a customer's reward points or monetary rewards (e.g., doubling or tripling a customer's balance) based on various customer behavior. While the above examples are merely illustrative, it will be understood that other bonuses, or enhancers, may be used as desired.

Further, according to aspects of the disclosure, the loyalty program may reward a customer (e.g., with bonuses, or enhancers, such as described above) when the customer exhibits particular behavior. For example, the loyalty program may reward a customer when the customer exhibits particular bank related behavior. For example, the loyalty program may reward a customer for bank related behavior that is not based on debit card transactions or credit card transactions.

According to aspects of the disclosure, the loyalty program may reward a customer for opening an account with the organization or keeping a predetermined balance in an account for a predetermined amount of time. Further, according to aspects of the disclosure, the loyalty program may reward a customer for having a relationship with the organization that exceeds a predetermined length of time (e.g., 5 years) or for doing a predetermined amount of business which exceeds a predetermined amount of money (e.g., $10,000). Further, according to aspects of the disclosure, the loyalty program may reward a customer for having multiple accounts with the organization (e.g., a mortgage loan, a car loan, a Home Equity Line of Credit (HELOC), a credit card, a checking account, a savings account, and the like). Further, according to aspects of the disclosure, the loyalty program may reward a customer for setting up direct deposit (e.g., income from a salary from an employer) or setting up a direct debit or automatic billing of different credit accounts the customer has with the bank (e.g., automatic payments from the customer's checking account to a mortgage loan, a car loan, a HELOC, a credit card, and the like).

Further, according to aspects of the disclosure, the loyalty program may reward a customer for making a predetermined amount of eligible transactions over a predetermined amount of time (e.g., conducting 25 transactions in a month/300 transactions in a year, and the like) or conducting a predetermined amount of business over a predetermined amount of time (e.g., $10,000 in transactions over a year). Further, according to aspects of the disclosure, the loyalty program may reward a customer for using the bank's online banking system to pay at least a predetermined amount of bills or agreeing to receive correspondence (e.g., monthly bank statements, bills on loans the customer has with the bank, payment reminders, and the like) electronically instead of through paper mail. Further, according to aspects of the disclosure, the loyalty program may reward a customer for making a first transaction after registering for the loyalty program or after making a predetermined number of payments after registering for the loyalty program.

Further, according to aspects of the disclosure, the loyalty program may reward a customer for making a predetermined amount of “on-time” payments to an account with the bank (e.g., mortgage, car loan, HELOC, or credit card, and the like) or making “on-time” payments for a predetermined amount of time (e.g., 4 years). While the above examples are merely illustrative, it will be understood that other customer behavior may be rewarded under the loyalty program (e.g., through bonuses or enhancers) as desired.

As discussed above, according to aspects of the disclosure, a customer may accumulate reward points or monetary rewards from different types of financial transactions into a single account (e.g., a reward points or monetary rewards account). Further, according to aspects of the disclosure, a customer may accumulate reward points or monetary rewards from different types of financial accounts the customer has with an organization into a single account (e.g., a reward points or monetary rewards account). For example, the above discussion references personal accounts a customer may have with an organization. However, other types of accounts associated with the customer (e.g., small business accounts or corporate accounts) may also accumulate reward points or monetary rewards and such reward points or monetary rewards may be accumulated into the single reward points or monetary rewards account that the reward points or monetary rewards accumulated from financial transactions in the customer's personal accounts are accumulated.

For example, according to aspects of the disclosure, a loyalty program may reward financial transactions (e.g., credit card transaction and debit card transactions) from non-personal accounts (e.g., small business or corporate accounts) with reward points or monetary rewards (e.g., such as described above). Further, such reward points or monetary rewards may be accumulated into a single account which may be a single reward points or monetary rewards account primarily associated with the customer and not necessarily primarily associated with either the personal accounts or the non-personal accounts (e.g., small business or corporate accounts). It is noted that the reward points or monetary rewards based on the financial transactions, customer behavior, and the like, associated with the non-personal accounts may be generated and accumulated into the single account according the methods and systems described above with regard to the customer's personal accounts.

Further, according to aspects of the disclosure, a loyalty program may reward financial transactions (e.g., credit card transaction and debit card transactions) from joint accounts, household accounts, and the like, with reward points or monetary rewards. Further, such reward points or monetary rewards may be accumulated into a single account which may be a single account primarily associated with the customer and not necessarily primarily associated with either the personal accounts or the joint accounts, household accounts, and the like. It is noted that the reward points or monetary rewards based on the financial transactions, customer behavior, and the like, associated with the joint accounts, household accounts, and the like, may be generated and accumulated into the single account according the methods and systems described above with regard to the customer's personal accounts.

According to aspects of the disclosure, purchases not related to a customer's financial accounts with a particular organization operating the loyalty program may also be eligible for reward points or monetary rewards from the loyalty program. For example, according to aspects of the disclosure, a loyalty program may reward a customer for making purchases with a particular third party vendor.

For example, according to aspects of the disclosure, a third party, for example, company A, may have a relationship with a bank and the bank may wish to promote sales at company A. Hence, according to aspects of the disclosure, in order to encourage purchases at company A, the bank may allow any purchases at company A to be eligible for reward points or monetary rewards with the bank under the loyalty program. For example, according to aspects of the disclosure, a customer who makes a cash transaction with company A may be eligible to receive reward points or monetary rewards based on the cash transaction with company A. For example, if a customer makes a cash purchase in the amount of $10 with company A, then the bank may award the customer 10 reward points or $0.01 in monetary rewards and credit the customer's reward account in the amount of 10 reward points or $0.01 in monetary rewards. Of course, different ratios, such as described above may be used. It is noted that, if desired, some or all of the reward points or monetary rewards credited to the customer based on the transaction with company A may be funded by company A. Further, according to aspects of the disclosure, the customer or the company A may submit receipts from the transaction (e.g., electronically, such as receipts in PDF, or conventionally, such as mailing the receipts) to the bank in order to obtain the reward points or monetary rewards credit.

Further, according to aspects of the disclosure, credit card or debit card transactions with the company A may be eligible for reward points or monetary rewards, even if the credit card or debit card was issued from a second bank, such as a bank different from the bank with which the rewards account is held. For example, if a customer with a rewards account at a first bank makes a credit card purchase at company A in the amount of $20 with a credit card issued by a second bank, according to aspects of the disclosure, the first bank may still reward the customer's rewards account in the amount of 20 rewards points or $0.02 in monetary rewards. Further, according to aspects of the disclosure, financial transaction information from the transaction may be transferred to the first bank electronically, such as, by company A. For example, according to aspects of this disclosure, during the transaction, company A may transmit information regarding the financial transaction to the bank via a computer system for transmitting and receiving financial transaction data, such as described above. For example, the company A may transmit financial transaction information during a request for approval of the transaction to the bank via the computer system for receiving financial transaction data. Of course, if desired, according to aspects of the disclosure, the customer or company A may also submit receipts from the credit card or debit card transaction (e.g., electronically, such as receipts in PDF, or conventionally, such as mailing the receipts) to the bank in order to obtain the reward points or monetary rewards credit.

It is noted that similarly to the above described situation in which a customer has different accounts within the same organization, or financial institution, a customer may have different accounts with different organizations or financial institutions. Therefore, the customer may generate reward points or monetary rewards in each of the several different accounts at the different organizations or financial institutions. Similarly to the above described drawbacks involving different accounts within the same organization or financial institution, a drawback to having reward points or monetary rewards in several different accounts at the different organizations, or financial institutions, may be that accumulating reward points or monetary rewards in any one of such rewards accounts to a predetermined level may take a longer period of time than it would if such points or monetary rewards were accumulated in a single account. Hence, accumulating a predetermined amount of monetary rewards or enough reward points to redeem a particular good or service may take a longer period of time than it would if such points or monetary rewards were accumulated in a single account.

According to aspects of the disclosure, reward points or monetary rewards from a customer's financial accounts with different organizations, companies, financial institutions may be accumulated in single account. For example, according to aspects of the disclosure, a loyalty program may extend between different organizations, companies, financial institutions, and the like and reward points or monetary rewards from any of those different organizations, companies, financial institutions, and the like, may be accumulated in single account. Further, such reward points or monetary rewards may be accumulated into a single account which may be a single account primarily associated with the customer and not necessarily primarily associated with any of the different organizations, financial institutions, and the like. It is noted that the reward points or monetary rewards based on the financial transactions, customer behavior, and the like, associated with the different organizations, financial institutions, and the like, may be generated and accumulated into the single account according the methods and systems described above with regard to the customer's personal accounts.

According to aspects of the disclosure, a customer may register any of the customer's credit cards or debit cards (e.g., credit cards or debit cards issued by any organization, financial institution, and the like) with the bank. Further, according to aspects of the disclosure, when the customer conducts a transaction with the any of the registered credit or debit cards, a message regarding the financial transaction may be sent to the bank notifying the bank of the financial transaction and/or the amount of reward points or monetary rewards that may be rewarded to the customer (and, therefore, accumulated into the customer's rewards account) based on the financial transaction. For example, according to aspects of this disclosure, during the transaction, the merchant involved in the transaction may transmit information regarding the financial transaction to the bank via a computer system for transmitting and receiving financial transaction data, such as described above. For example, the merchant may transmit financial transaction information during a request for approval of the transaction to the bank via the computer system for receiving financial transaction data. Of course, if desired, according to aspects of the disclosure, the customer or merchant may also submit receipts from the credit card or debit card transaction (e.g., electronically, such as receipts in PDF, or conventionally, such as mailing the receipts) to the bank in order to obtain the credit.

According to aspects of the disclosure, under a loyalty program the customer may redeem rewards points for goods and services, such as travel vouchers (e.g., for hotels, airplane tickets, and the like), merchandise, or even gift certificates and cash. According to aspects of the disclosure, there may be a cap on the amount of reward points or monetary rewards the customer may accumulate. Further, according to aspects of the disclosure, there may also be a cap on the amount of points or monetary rewards from a particular aspect of the loyalty program. For example, the amount of points or monetary rewards from: debit cards, credit cards, signature authorized transactions, PIN authorized transactions, transactions wherein credit cards or debit cards not issued by the organization that operates said loyalty program. Further, there may be a cap on the bonuses, or enhancers, the customer may receive through the loyalty program. According to other aspects of the program, there may be no cap on the amount of points or monetary rewards in the loyalty program or from a particular aspect of the loyalty program. According to aspects of the disclosure, the loyalty program may, or may not, be a fee based service.

It is noted that while some aspects of the disclosure may relate to rewards points or monetary rewards, other aspects of the disclosure may relate to the other features of the loyalty program, such as travel vouchers or promotional items. According to aspects of the disclosure, such features of the loyalty program may be accumulated in a single account as well, in a manner such as described above.

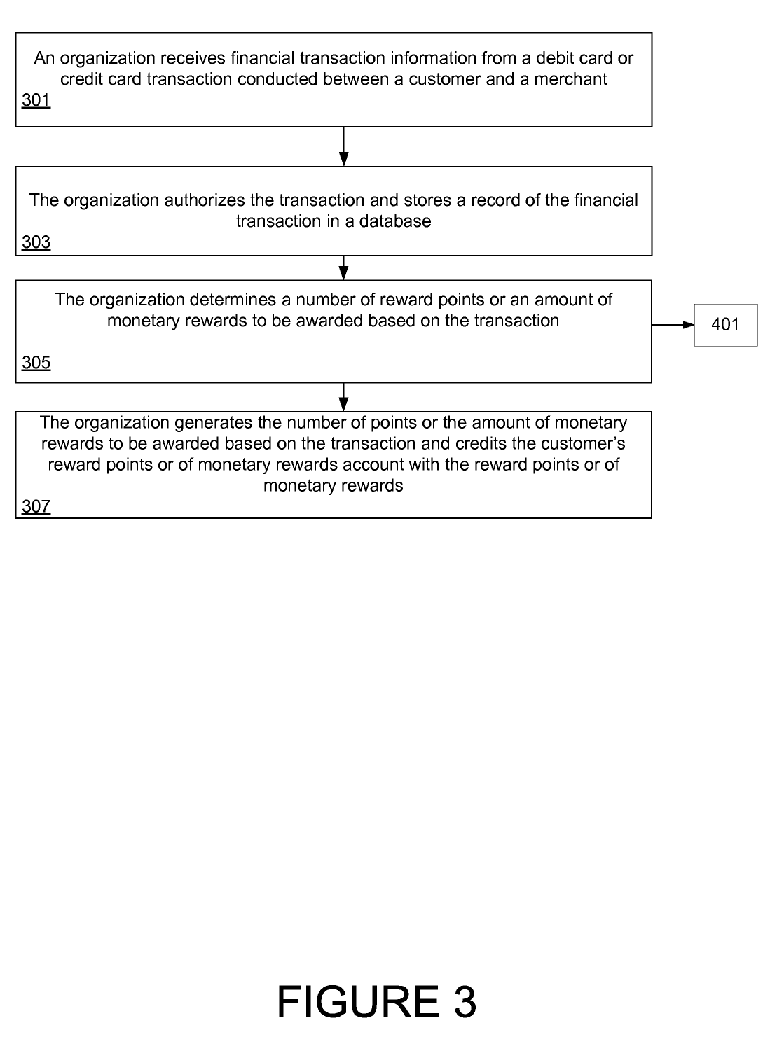

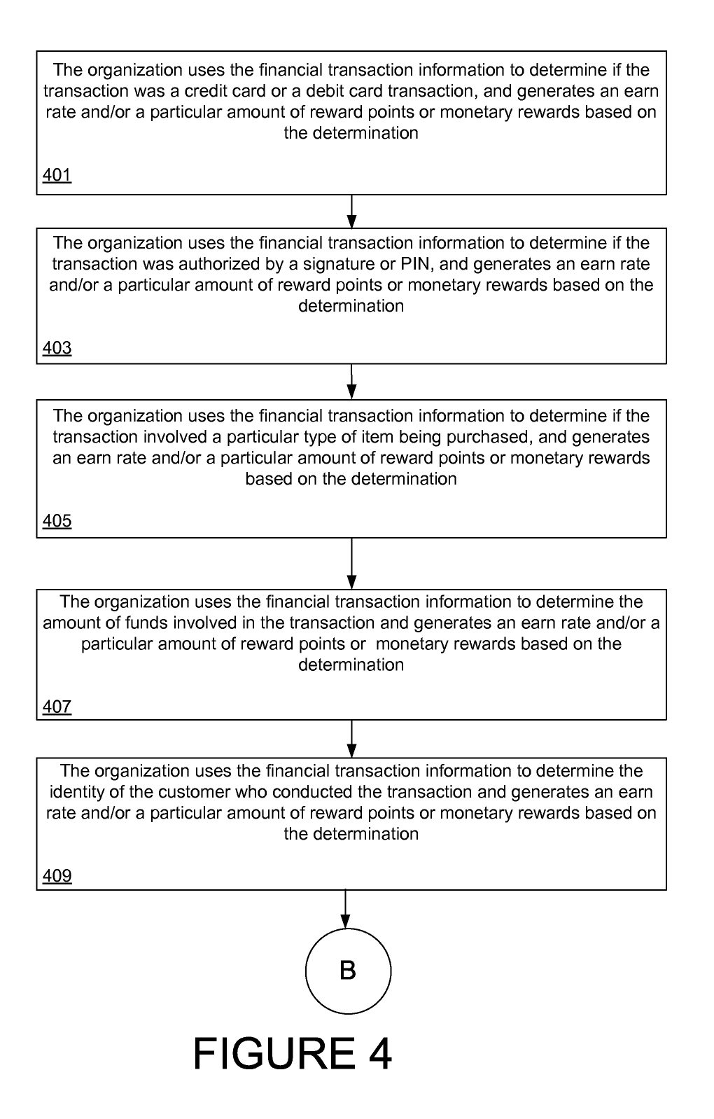

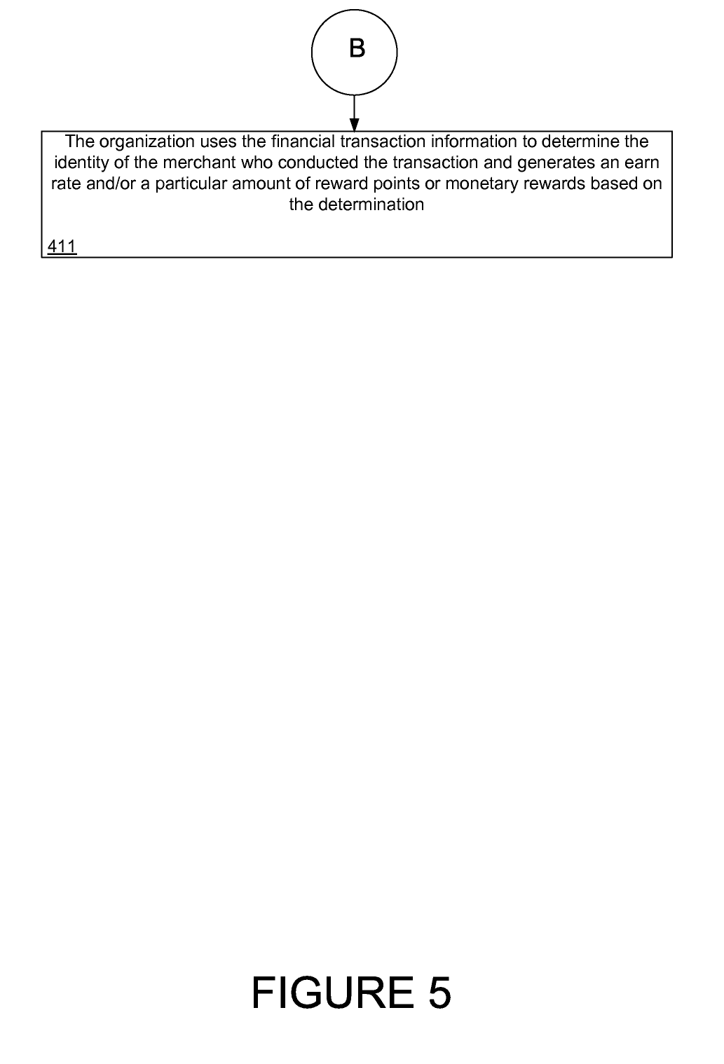

FIGS. 3, 4 and 5 are a flow chart which illustrates a method for generating reward points or monetary rewards and accumulating reward points or monetary rewards into a single account according to aspects of this disclosure. According to aspects of the disclosure the method may be performed autonomously by a computer or manually via a computer assisted method.

As seen in step 301, an organization may receive financial transaction information from a debit card or credit card transaction conducted between a customer and a merchant. For example, the organization may receive financial transaction information from a debit card or credit card transaction electronically as described above with regard to FIG. 2. In step 303, the organization may authorize the transaction and store a record of the financial transaction in a database. In step 305, the organization may determine a number of reward points or an amount of monetary rewards to be awarded based on the transaction. Steps 401-411 detail various steps the organization may use to determine a number of reward points or an amount of monetary rewards to be awarded based on the transaction in step 305. For example, as seen in steps 401-411 the organization may use the financial transaction information to determine if the transaction was a credit card or a debit card transaction, if the transaction was authorized by a signature or PIN, if the transaction involved a particular type of item being purchased, the amount of funds involved in the transaction, the identity of the customer who conducted the transaction, and the identity of the merchant who conducted the transaction. Of course, other factors and criteria may be determined and used as well. Based on the above determinations, the organization may generate an earn rate and/or a particular amount of reward points or monetary rewards based on the determination. In step 307, the organization may generate the number of points or the amount of monetary rewards to be awarded based on the transaction and may credit the customer's reward account with the reward points or monetary rewards. It is noted that steps or elements of this or any other process may be rearranged, combined, eliminated or otherwise modified as desired to produce a desired result.

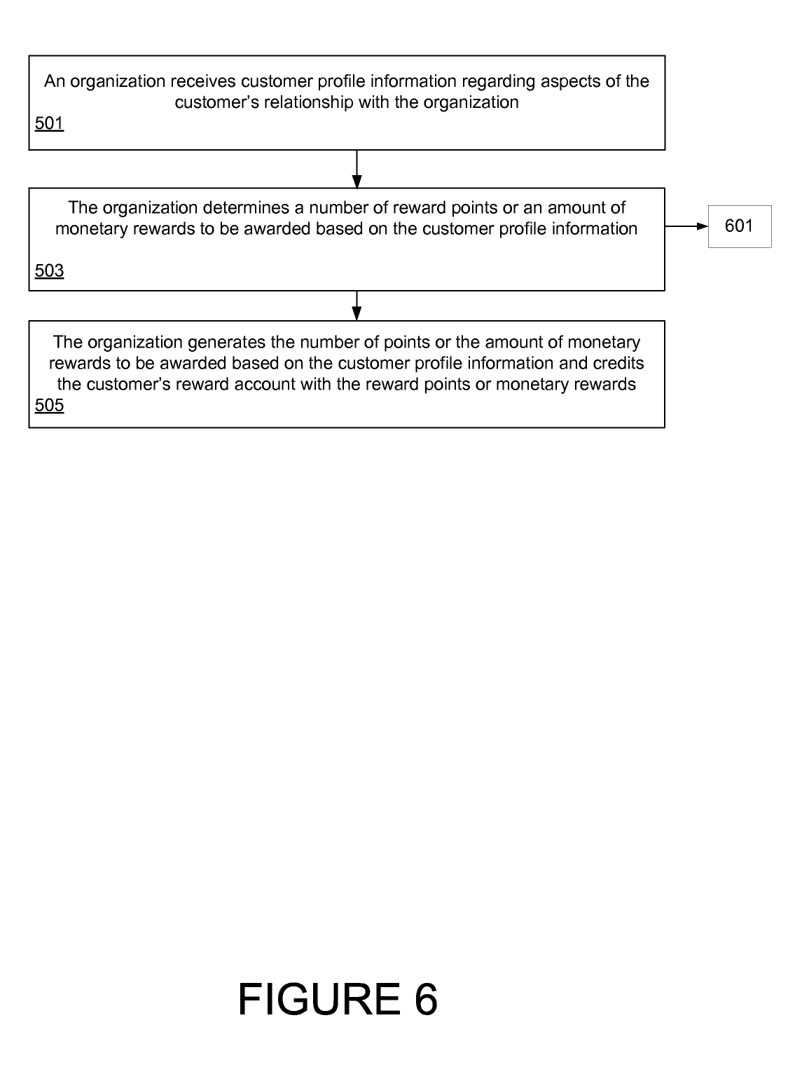

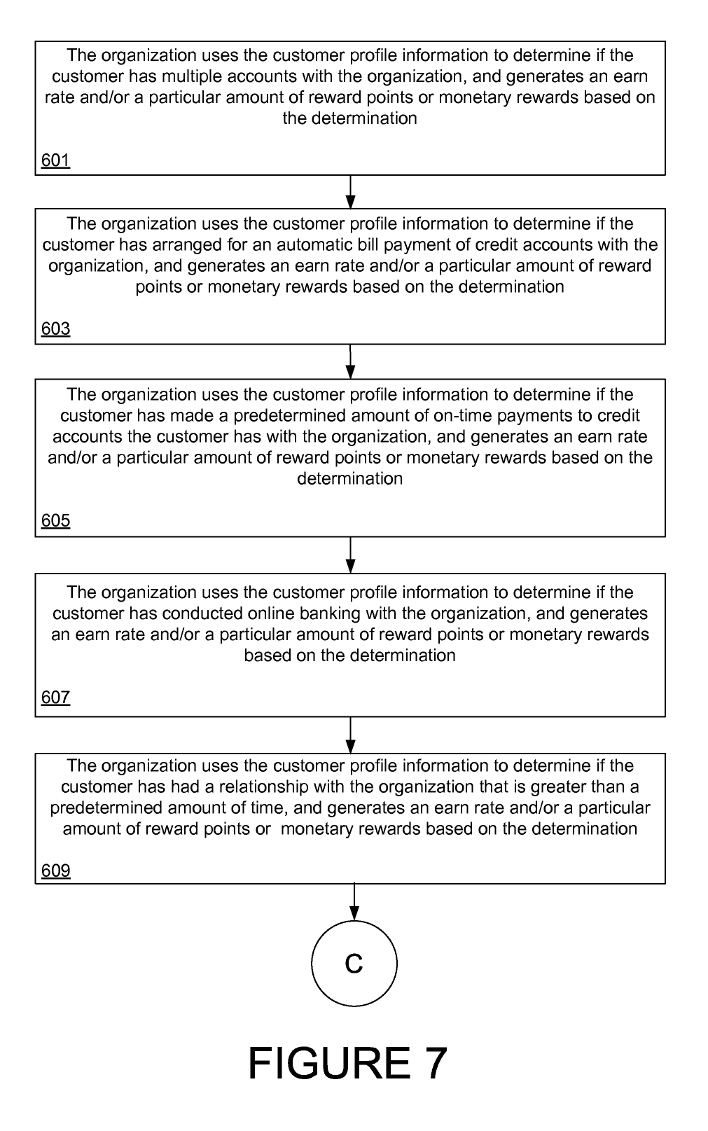

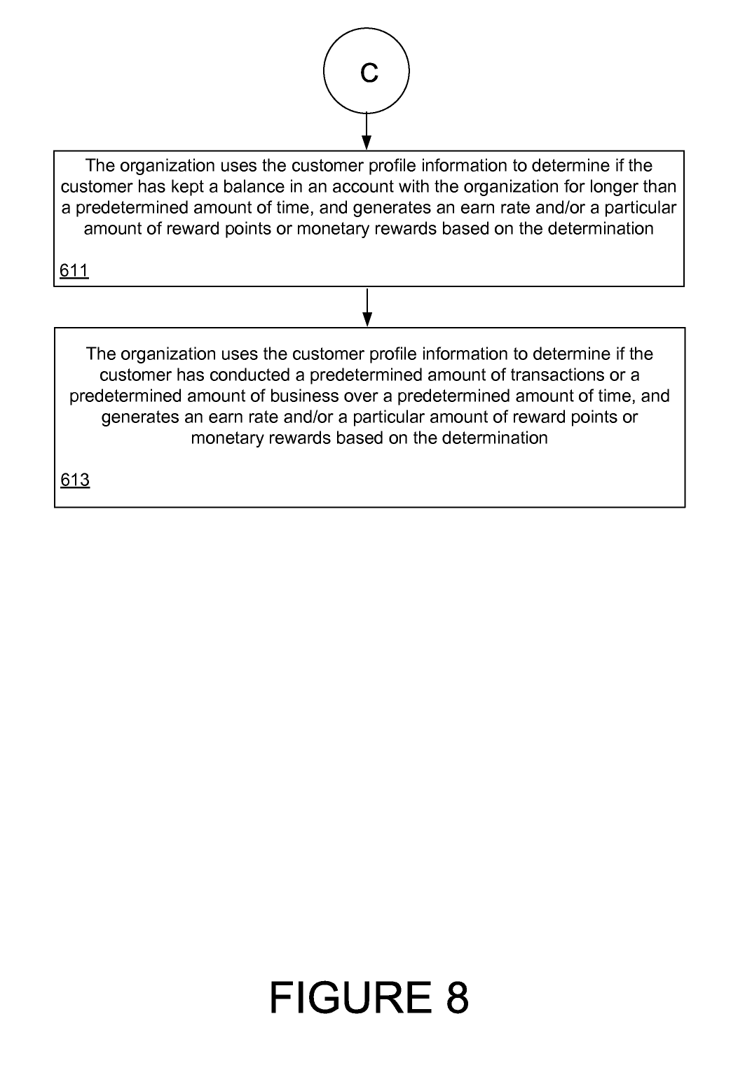

FIGS. 6, 7 and 8 are a flow chart which illustrates a method for generating reward points or monetary rewards and accumulating reward points or monetary rewards into a single account according to aspects of this disclosure. According to aspects of the disclosure the method may be performed autonomously by a computer or manually via a computer assisted method.

As seen in step 501, an organization may receive customer profile information regarding aspects of the customer's relationship with the organization. In step 503, the organization determines a number of reward points or an amount of monetary rewards to be awarded based on the customer profile information. Steps 601-613 detail various steps the organization may use to determine a number of reward points or an amount of monetary rewards to be awarded based on the transaction in step 503. For example, as seen in steps 601-613 the organization may use the customer profile information to determine if the customer has multiple accounts with the organization, if the customer has arranged for an automatic bill payment of credit accounts with the organization, if the customer has made a predetermined amount of on-time payments to credit accounts the customer has with the organization, if the customer has conducted online banking with the organization, if the customer has had a relationship with the organization that is greater than a predetermined amount of time, if the customer has kept a balance in an account with the organization for longer than a predetermined amount of time, and if the customer has conducted a predetermined amount of transactions or a predetermined amount of business over a predetermined amount of time. Of course, other factors and criteria may be determined and used as well. Based on the above determinations, the organization may generate an earn rate and/or a particular amount of reward points or a particular amount of monetary rewards based on the determination. In step 505, the organization may generate the number of points or the amount of monetary rewards to be awarded based on the customer profile information and may credit the customer's reward account with the reward points or monetary rewards. It is noted that steps or elements of this or any other process may be rearranged, combined, eliminated or otherwise modified as desired to produce a desired result.

It is noted that the system for generating reward points or monetary rewards and accumulating reward points or monetary rewards into a single account according to aspects of this disclosure may be an electronically based system. For example, the system may include a computer (such as described above), a network of computers, software that configures a computer to perform the above described features, and the like. The data may be electronically transmitted and received by the different elements of the system.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the features of the aforementioned illustrative examples may be utilized alone or in combination or subcombination with elements of the other examples. It will also be appreciated and understood that modifications may be made without departing from the true spirit and scope of the present invention. The description is thus to be regarded as illustrative instead of restrictive on the present invention.

1. A computer assisted method for consolidating reward points or monetary rewards comprising:
electronically receiving information regarding a financial transaction in a first financial account;
determining an amount of reward points or monetary rewards based on the financial transaction in the first financial account;
crediting a reward points or monetary rewards account associated with the first financial account with the amount of reward points or monetary rewards based on the financial transaction associated with the first financial account;
electronically receiving information regarding a transaction in a second financial account;
determining an amount of reward points or monetary rewards based on the financial transaction in the second financial account;
crediting the reward points or monetary rewards account with the amount of reward points or monetary rewards based on the financial transaction associated with the second financial account; and
consolidating the reward points or monetary rewards associated with the first financial account with the reward points or monetary rewards associated with the second financial account,
wherein the first financial account is located at a first financial institution and the second financial account is located at a second financial institution,
wherein the first financial account is a credit card account and the second financial account is a debit card account,
wherein an earn rate of rewards points or monetary rewards for the first financial transaction is based on whether the financial transaction is authorized by a signature or by a Personal Identification Number (PIN),
wherein the earn rate is based on whether the first financial account has maintained a minimum balance for at least a predetermined amount of time, and
wherein the electronically receiving, the determining, the crediting, and the consolidating are performed by a computer system.

2. The method according to claim 1, further comprising determining the earn rate based, at least in part, on the electronically received information, wherein the earn rate is determined based on the amount of funds involved in the financial transaction.

3. The method according to claim 1, further comprising determining the earn rate based, at least in part, on the electronically received information, wherein the earn rate is determined based on whether the financial transaction involved a credit card or a debit card.

4. The method according to claim 1, further comprising determining the earn rate based, at least in part, on the electronically received information, wherein the earn rate is determined based on items purchased in the financial transaction.

5. The method according to claim 1, further comprising determining the earn rate based, at least in part, on the electronically received information, wherein the earn rate is determined based on the identity of a customer involved in the financial transaction.

6. The method according to claim 1, further comprising electronically receiving information regarding a customer's relationship with an organization awarding the reward points or monetary rewards, determining an amount of reward points or monetary rewards or an earn rate based on the information regarding the customer's relationship with the organization.

7. The method according to claim 6, wherein the amount of reward points or monetary rewards or the earn rate is based on whether the customer associated with the first financial account has multiple accounts with the organization.

8. The method according to claim 6, wherein the amount of reward points or monetary rewards or the earn rate is based on whether the customer has made a predetermined amount of on-time payments to one or more credit accounts the customer has with the organization.

9. The method according to claim 6, wherein the amount of reward points or monetary rewards or the earn rate is based on whether the customer has had a relationship with the organization that is greater than a predetermined amount of time.

10. The method according to claim 6, wherein the amount of reward points or monetary rewards or the earn rate is based on whether the customer has conducted a predetermined amount of transactions or a predetermined amount of business over a predetermined amount of time.

11. A reward points or monetary rewards consolidating computer comprising:
a processor; and
memory storing computer executable instructions that, when executed, cause the processor to perform a method wherein reward points or monetary rewards associated with two or more financial accounts are generated and consolidated into a single account by:
electronically receiving information regarding a financial transaction in a first financial account;
determining an amount of reward points or monetary rewards based on the financial transaction in the first financial account;
crediting a reward points or monetary rewards account associated with the first financial account with the amount of reward points or monetary rewards based on the financial transaction associated with the first financial account;
electronically receiving information regarding a transaction in a second financial account;
determining an amount of reward points or monetary rewards based on the financial transaction in the second financial account;
crediting the reward points or monetary rewards account with the amount of reward points or monetary rewards based on the financial transaction associated with the second financial account;
consolidating the reward points or monetary rewards associated with the first financial account with the reward points or monetary rewards associated with the second financial account,
wherein the first financial account is located at a first financial institution and the second financial account is located at a second financial institution,
wherein the first financial account is a credit card account and the second financial account is a debit card account, and
wherein an earn rate of rewards points or monetary rewards for the first financial transaction is based on whether the financial transaction is authorized by a signature or by a Personal Identification Number (PIN), and
wherein the earn rate is based on whether the first financial account has maintained a minimum balance for at least a predetermined amount of time.

12. The computer according to claim 11, wherein the method further comprises determining the earn rate based, at least in part, on the electronically received information, wherein the earn rate is determined based on the amount of funds involved in the financial transaction.

13. The computer according to claim 11, wherein the method further comprises determining the earn rate based, at least in part, on the electronically received information, wherein the earn rate is determined based on whether the financial transaction involved a credit card or a debit card.

14. The computer according to claim 11, wherein the method further comprises determining the earn rate based, at least in part, on the electronically received information, wherein the earn rate is determined based on items purchased in the financial transaction.

15. The computer according to claim 11, wherein the method further comprises determining the earn rate based, at least in part, on the electronically received information, wherein the earn rate is determined based on the identity of a customer involved in the financial transaction.

16. The computer according to claim 11, wherein the method further comprises electronically receiving information regarding a customer's relationship with an organization awarding the reward points or monetary rewards, determining an amount of reward points or monetary rewards or an earn rate based on the information regarding the customer's relationship with the organization.

17. The computer according to claim 16, wherein the amount of reward points or monetary rewards or the earn rate is based on whether the customer has multiple accounts with the organization.

18. The computer according to claim 16, wherein the amount of reward points or monetary rewards or the earn rate includes determining if the customer has made a predetermined amount of on-time payments to one or more credit accounts the customer has with the organization.

19. The computer according to claim 16, wherein the amount of reward points or monetary rewards or the earn rate is based on whether the customer has had a relationship with the organization that is greater than a predetermined amount of time.

20. A computer assisted method for consolidating reward points or monetary rewards comprising:
electronically receiving information regarding a financial transaction in a first financial account;
determining an amount of reward points or monetary rewards based on the financial transaction in the first financial account;
crediting a reward points or monetary rewards account associated with the first financial account with the amount of reward points or monetary rewards based on the financial transaction associated with the first financial account;
electronically receiving information regarding a transaction in a second financial account;
determining an amount of reward points or monetary rewards based on the financial transaction in the second financial account;
crediting the reward points or monetary rewards account with the amount of reward points or monetary rewards based on the financial transaction associated with the second financial account;
electronically receiving information regarding a relationship a customer has with an organization awarding the reward points or monetary rewards;
determining an earn rate of reward points or monetary rewards based on the information regarding the relationship the customer has with the organization,
wherein the earn rate is based on whether the first financial account has maintained a minimum balance for at least a predetermined amount of time,
wherein the earn rate is a first value when the financial transaction involved a credit card,
wherein the earn rate is a second value when the financial transaction involved a debit card,
wherein the information regarding the customer relationship comprises a number of accounts the customer has with the organization, and
wherein the electronically receiving, the determining, and the crediting are performed by a computer system.
